(19) United States
(12) Patent Application Publication
(10) Pub. No.: US 2021/0372486 A1
(43) Pub. Date: Dec. 2, 2021

(54) DEPTH-CONTROLLING CLUTCH

(71) Applicant: MEENG GANE ENTERPRISE CO., LTD, Taichung (TW)

(72) Inventor: YU-JYUN LEE, Taichung (TW)

(21) Appl. No.: 16/886,799

(22) Filed: May 29, 2020

(51) Int. Cl. F16D 7/10; B25B 23/00; B25B 23/14

(52) U.S. Cl. CPC F16D 7/10; F16D 27/01; B25B 23/14; B25B 23/0064

(57) ABSTRACT

A clutch includes balls, an axle, a socket and a cylinder. The axle includes a circular section formed with alternate cavities and ridges. The socket includes a circular bore for receiving the circular section of the axle and apertures for receiving the balls. The cylinder includes an annular recess made in an internal face. The socket is movable in the cylinder between two positions. When the socket is the first position, the internal face of the cylinder abuts the external portions of balls to engage the internal portions of the balls with the ridges to cause the axle to rotate the socket via the balls. When the socket is in the second position, the annular recess receives the external portions of the balls to allow disengagement of the internal portions of balls from the ridges to allow the axle to rotate relative to the socket.

### BACKGROUND OF INVENTION

### 1. Field of Invention

The present invention relates to a screwdriver and, more particularly, to a clutch used in a pneumatic or electric screwdriver to control the depth at which the screwdriver drives a screw into two workpieces.

### 2. Related Prior Art

A screw includes a head formed at an end of a threaded section. A pneumatic or electric screwdriver is often engaged with the head of the screw to drive the threaded section of the screw into two workpieces to connect the workpieces to each other. The pneumatic or electric screwdriver can be used to drive the threaded section of the screw out of the workpieces so that the workpieces are detachable from each other. The pneumatic or electric screwdriver often exerts large torque on the head of the screw and drives the threaded section of the screw into the workpieces fast. Hence, the pneumatic or electric screwdriver often drives the threaded section of the screw too deep into the workpieces so that even the head of the screw is driven into an upper one of the workpieces. Thus, the upper workpieces is damaged by the screw, and this is not desirable.

The present invention is therefore intended to obviate or at least alleviate the problems encountered in prior art.

### SUMMARY OF INVENTION

It is the primary objective of the present invention to provide a pneumatic or electric screwdriver with a clutch to control the depth at which the screwdriver drives a screw into two workpieces.

To achieve the foregoing objective, the clutch includes balls, an axle, a socket and a cylinder. The axle includes a circular section formed with alternate cavities and ridges. The socket includes a circular bore for receiving the circular section of the axle and apertures for receiving the balls. A sum of a thickness of the apertures and a thickness of the cavities is equal to or larger than a diameter of the balls. The cylinder includes an annular recess made in an internal face. The socket is movable in the cylinder between two positions. When the socket is the first position relative to the cylinder, the internal face of the cylinder abuts the external portions of balls to insert the internal portions of the balls in the cavities and engage the internal portions of the balls with the ridges to cause the axle to rotate the socket via the balls. When the socket is in the second position relative to the cylinder, the annular recess receives the external portions of the balls to allow movement of the internal portions of balls from the cavities and disengagement of the internal portions of balls from the ridges to allow the axle to rotate relative to the socket.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a depth-controlling clutch according to the preferred embodiment of the present invention;

FIG. 2 is a cross-sectional view of the depth-controlling clutch shown in FIG. 1;

FIG. 3 is a front view of the depth-controlling clutch shown in FIG. 1;

FIG. 4 is a cross-sectional view of the depth-controlling clutch shown in FIG. 3 arranged between a bit and an axle;

FIG. 5 is another cross-sectional view of the depth-controlling clutch and axle shown in FIG. 4;

FIG. 6 is a cross-sectional view of the depth-controlling clutch, bit and axle in another position relative to two workpieces than shown in FIG. 4; and

FIG. 7 is a cross-sectional view of the depth-controlling clutch and axle shown in FIG. 6.

### DETAILED DESCRIPTION OF PREFERRED EMBODIMENT

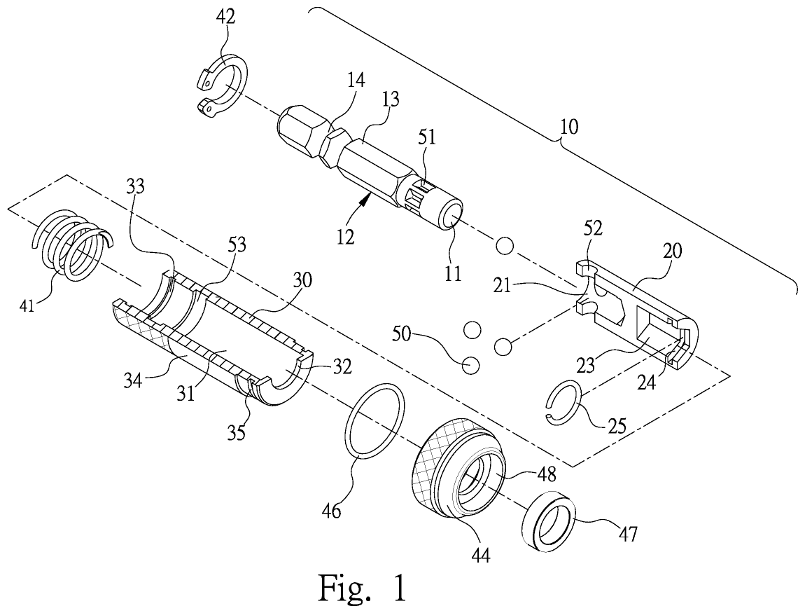

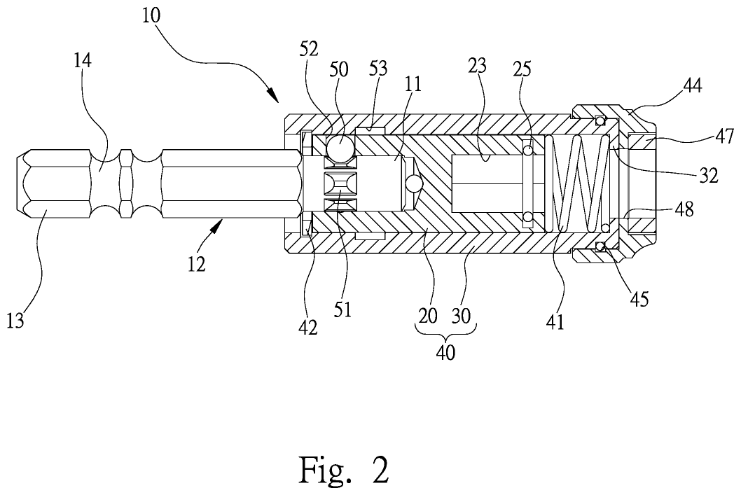

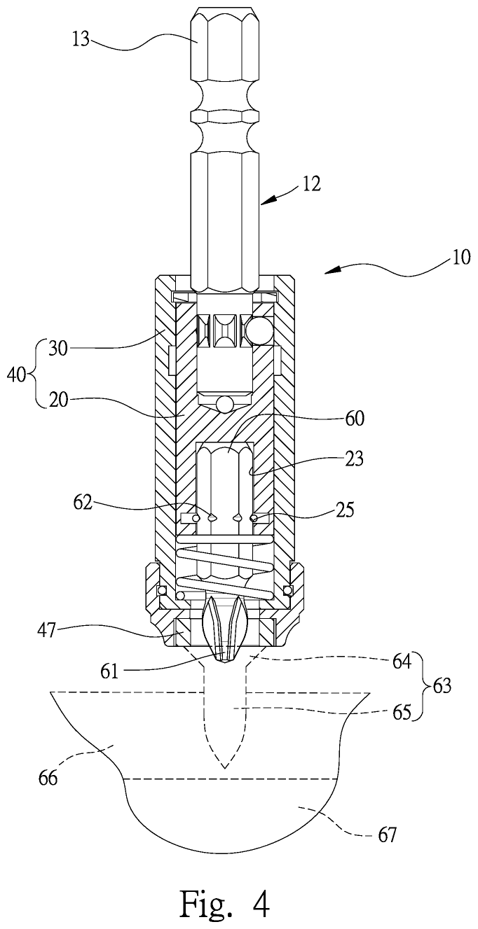

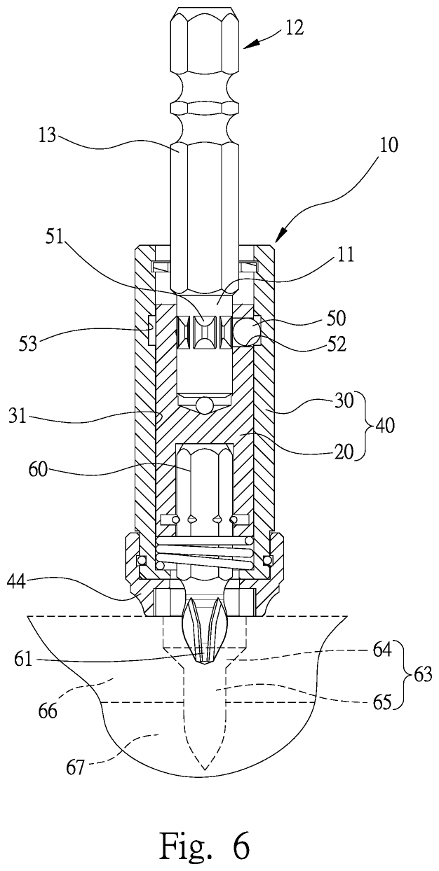

Referring to FIGS. 1 and 2, according to the preferred embodiment of the present invention, a clutch 10 is used in a pneumatic or electric screwdriver to control the depth at which the screwdriver drives a screw 63 into an upper workpiece 66 and a lower workpiece 67 (FIGS. 4 and 6). The clutch 10 includes an axle 12, a telescopic shell 40 and a centrifugal mechanism (not numbered). The centrifugal mechanism is arranged between the circular section 11 and the telescopic shell 40.

The axle 12 is formed with a circular section 11, a polygonal section 13 opposite to the circular section 11 and a reduced section 14 between the circular section 11 and the polygonal section 13. In use, the polygonal section 13 is engaged with the pneumatic or electric screwdriver. Thus, the axle 12 is used as an extensive element.

The telescopic shell 40 includes a socket 20 and a cylinder 30. The socket 20 is inserted in the cylinder 30. The socket 20 is movable relative to the cylinder 30 in an axial direction of the telescopic shell 40. The socket 20 includes a circular bore 21 made in an upper section and a polygonal bore 23 made in a lower section. The circular bore 21 is separated from the polygonal bore 23 in the preferred embodiment. However, the circular bore 21 can be in communication with the polygonal bore 23 in another embodiment. The socket 20 further includes an annular groove 24 made in a wall of the polygonal bore 23. An elastic ring 25 includes an external portion inserted in the annular groove 24.

The cylinder 30 is formed with an internal face 31 and an external face 34. The cylinder 30 includes a annular flange 32 formed on the internal face 31 near a lower end, an annular groove 33 made in the internal face 31 near an upper end, and an annular recess 53 made in the internal face 31.

In assembly, the annular groove 33 receives a C-shaped clip 42 that extends parallel to the annular flange 32. The clip 42 is used to abut an upper end of the socket 20 to keep the socket 20 in the cylinder 30. That is, the clip 42 is used as a limit for the movement of the socket 20 in the cylinder 30. A compression spring 41 is compressed between a lower end of the socket 20 and the annular flange 32 so that the compression spring 41 is kept in the cylinder 30. The compression spring 41 keeps the annular flange 32 of the cylinder 30 from the socket 20.

The telescopic shell 40 further includes a collar 44 that looks like “H” in a cross-sectional view like FIG. 2. The collar 44 includes a channel 48 between an upper portion and a lower portion. An internal portion of a ring 46 is inserted in an annular groove 35 made in the external face 34 of the cylinder 30. An external portion of the ring 46 is inserted in an annular groove 45 made in an internal face of the upper portion of the collar 44. Thus, the lower end of the cylinder 30 is kept in the upper portion of the collar 44. An annular permanent magnet 47 is fitted in the lower portion of the collar 44. A central aperture made in the magnet 47, the channel 48, a central aperture made in the annular flange 32, an axial channel defined in the compression spring 41 and the polygonal bore 23 are in communication with one another.

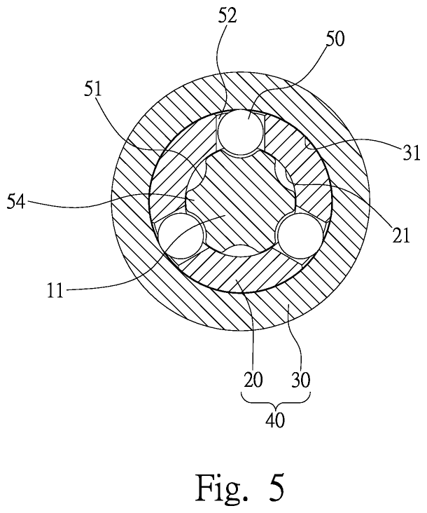

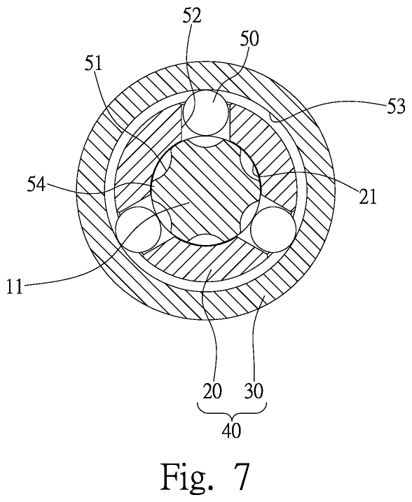

Further referring to FIGS. 5 and 7, the centrifugal mechanism includes balls 50, cavities 51, apertures 52, an annular recess 53 and ridges 54. The cavities 51 are made in the periphery of the circular section 11 of the axle 12. The cavities 51 are separated from one another by the ridges 54. The apertures 52 are made in the upper section of the socket 20 so that the apertures 52 are in communication with the circular bore 21. The annular recess 53 is made in the internal face 31 of the cylinder 30, between the annular flange 32 and the clip 42. The depth of the annular recess 53 is identical to the depth of the cavities 51 in the preferred embodiment. Normally, an external face of the socket 20 closes the annular recess 53.

Each of the balls 50 includes an internal portion for insertion in one of the cavities 51 and an external portion for insertion in one of the apertures 52. The sum of the depth of the apertures 52 and the depth of the cavities 51 is equal to the diameter of the balls 50 so that the internal face 31 of the cylinder 30 abuts the external portion of each of the balls 50 as the axle 12 is in an upper position relative to the cylinder 30.

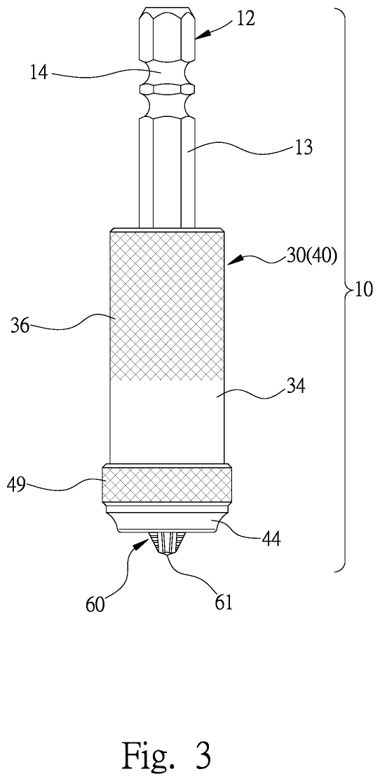

Referring to FIG. 3, an anti-skid face 36 is formed on a portion of the external face 34 of the cylinder 30. Moreover, anti-skid face 49 is formed on a portion of an external face of the collar 44. A user can firmly hold the anti-skid faces 36 and 49 of the telescopic shell 40 to connect the clutch 10 to a bit 60 without having to worry much about dropping the clutch 10 accidentally. After the connection, a driving end 61 of the bit 60 is located out of the collar 44 of the telescopic shell 40.

Referring to FIGS. 4 and 5, the centrifugal mechanism is in a connecting position as the socket 20 is in the upper position relative to the cylinder 30. The bit 60 is a polygonal element that includes corners (not numbered) and notches 62 made in the corners. When the bit 60 is inserted in the polygonal bore 23 of the socket 20, the notches 62 receive corresponding portions of the elastic ring 25 to retain the bit 60 in the socket 20 of the telescopic shell 40.

To drive the screw 63 into the upper and lower workpieces 66 and 67, the bit 60 is engaged with the screw 63 by insertion of the driving end 61 of the bit 60 in a corresponding cavity made in the head 64 of the screw 63. The screw 63 is attracted to the magnet 47 so that the head 64 of the screw 63 is kept in contact with the magnet 47. Thus, the user does not have to worry much about dropping the screw 63 from the magnet 47 of the telescopic shell 40 of the clutch 10 accidentally.

The pneumatic or electric screwdriver rotates the circular section 11 of the axle 12 via the polygonal section 13 of the axle 12. The ridges 54 abut against the balls 50 so that the axle 12 rotate the balls 50. In turn, the balls 50 abut the walls of the apertures 52 so that the balls 50 rotate the socket 20. In turn, the socket 20 rotates the bit 60. Finally, the bit 60 rotates the screw 63 since the driving end 61 of the bit 60 is engaged with the head 64 of the screw 63. Thus, a threaded section 65 of the screw 63 is driven into or out of the upper and lower workpieces 66 and 67.

Referring to FIGS. 6 and 7, the centrifugal mechanism is in a disconnecting position when the socket 20 is in a lower position relative to the cylinder 30. The use of the clutch 10 to control the depth at which the screw 63 is driven in the upper and lower workpieces 66 and 67 will be described. The collar 44 is abutted against an upper face of the upper workpiece 66. As mentioned above, the socket 20 is in a lower position relative to the cylinder 30 so that the cavities 51, the apertures 52 and the annular recess 53 are at a same height. Due to a centrifugal force exerted on the balls 50, the external portions of the balls 50 are cast into the annular recess 53 so that the internal portions of the balls 50 are cast out of the cavities 51. As sum of the depth of the annular recess 53 and the depth of the apertures 52 is equal to or larger than the diameter of the balls 50, the balls 50 are no longer engaged with the ridges 54. Thus, the circular section 11 of the axle 12 is allowed to rotate relative to the upper section of the socket 20. Accordingly, the socket 20 does not rotate the bit 60 so that the bit 60 does not rotate the screw 63. Hence, the screw 63 is not driven excessively deep into the upper and lower workpieces 66 and 67.

The compression spring 41 is fully compressed between the lower end of the socket 20 and the annular flange 32 of the cylinder 30. When the pneumatic or electric screwdriver is turned off, the axle 12 is not rotated. The pneumatic or electric screwdriver, the clutch 10 and the bit 60 are lifted so that the clutch 10 is removed from the upper workpiece 66 and the bit 60 is removed from the screw 63. Thus, the compression spring 41 is allowed to return the socket 20 to the upper position relative to the cylinder 30. Accordingly, the centrifugal mechanism is returned to the connecting position where the internal face 31 of the cylinder 30 abuts against the external portions of the balls 50 to keep the internal portions of the balls 50 in the cavities 51, i.e., against the ridges 54.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A depth-controlling clutch comprising:
balls each of which comprises an internal portion and an external portion;
an axle comprising a circular section formed with alternate cavities and ridges;
a socket comprising:
a circular bore for receiving the circular section of the axle; and
apertures for receiving the balls, wherein a sum of a thickness of the apertures and a thickness of the cavities is equal to or larger than a diameter of the balls; and
a cylinder comprising an internal face and an annular recess made in the internal face, wherein the socket is movable in the cylinder between a first position and a second position, wherein the internal face of the cylinder abuts the external portions of balls to insert the internal portions of the balls in the cavities and engage the internal portions of the balls with the ridges to cause the axle to rotate the socket via the balls when the socket is the first position relative to the cylinder, wherein the annular recess receives the external portions of the balls to allow movement of the internal portions of balls from the cavities and disengagement of the internal portions of balls from the ridges to allow the axle to rotate relative to the socket when the socket is in the second position relative to the cylinder.

2. The depth-controlling clutch according to claim 1, further comprising a compression spring for biasing the socket toward the first position relative to the cylinder.

3. The depth-controlling clutch according to claim 2, wherein the cylinder comprises an annular flange formed on the internal face, wherein the compression spring is compressed between the annular flange and an end of the socket.

4. The depth-controlling clutch according to claim 3, further comprising a clip engaged with the internal face of the cylinder and used for abutment against another end of the socket to keep the socket in the cylinder.

5. The depth-controlling clutch according to claim 1, wherein the socket further comprises a polygonal bore for receiving a bit.

6. The depth-controlling clutch according to claim 1, further comprising a magnet connected to the cylinder.

7. The depth-controlling clutch according to claim 6, wherein the cylinder comprises an anti-skid face formed on an external face.

8. The depth-controlling clutch according to claim 6, further comprising a collar connected to the cylinder, wherein the magnet is connected to the collar.

9. The depth-controlling clutch according to claim 8, wherein the collar comprises an anti-skid face formed on an external face.

10. The depth-controlling clutch according to claim 1, wherein the axle further comprises a polygonal section extending opposite to the circular section.
